(19) United States
(12) Patent Application Publication
(10) Pub. No.: US 2014/0191444 A1
(43) Pub. Date: Jul. 10, 2014

(54) APPARATUSES AND METHODS FOR EXTRUDING A BLOCK PRODUCT FROM A FEED MATERIAL

(71) Applicant: Koslow Technologies Corporation, Dallas, TX (US)

(72) Inventor: Evan E. Koslow, Dallas, TX (US)

(73) Assignee: Koslow Technologies Corporation, Dallas, TX (US)

(21) Appl. No.: 14/152,506

(22) Filed: Jan. 10, 2014

Related U.S. Application Data
(60) Provisional application No. 61/750,928, filed on Jan. 10, 2013.

(51) Int. Cl. B29C 47/86; B29C 35/14; B29C 33/08

(52) U.S. Cl. CPC B29C 47/862; B29C 33/08; B29C 35/14
USPC 264/449; 425/174.6

(57) ABSTRACT

An apparatus for extruding a block product from a feed material. A barrel includes an output end. A screw is at least partially disposed within the barrel. The screw flows the feed material in the barrel towards the output end. A die is in fluid communication with the output end of the barrel. The die receives the feed material and heats the feed material to produce the block product. At least one electrically conductive element passes electric current through the feed material to heat the feed material by resistive heating. The feed material may include activated carbon and at least one binder, to produce a carbon block product.

### RELATED APPLICATIONS

This application claims the benefit of U.S. Provisional Patent Application Ser. No. 61/750,928 filed Jan. 10, 2013, the entire contents of which are hereby incorporated by reference herein for all purposes.

### TECHNICAL FIELD

The present disclosure relates to extrusion processes, and more particularly to forming carbon block products using extrusion.

### INTRODUCTION

Carbon block is a filtration medium that may have various commercial uses, including in the production of consumer and industrial water filters. Some carbon block products may be composites that include activated carbon, at least one binder, and optionally other additives that are compressed and fused into generally coherent porous structure.

In some cases, a carbon block filter product may be shaped as a right circular cylinder with a hollow bore therethrough (which is usually also circular) so as to form a tube. In some applications, the flow of water or other fluids may be directed generally in a radial direction through the wall of this tube (either outwardly or inwardly). Passage of the fluid through this carbon block filter product, which is porous and adsorbent, may result in a reduction of one or more of particulate and chemical contaminants in the fluid.

### SUMMARY

The following summary is intended to introduce the reader to the detailed description that follows and not to define or limit the claimed subject matter.

In an aspect of the present disclosure, an apparatus for extruding a block product from a feed material is described. The apparatus may include: a barrel including an output end; a screw at least partially disposed within the barrel, and adapted to flow the feed material in the barrel towards the output end; a die in fluid communication with the output end of the barrel, and adapted to receive the feed material and heat the feed material to produce the block product; and at least one electrically conductive element for passing electric current through the feed material to heat the feed material by resistive heating.

In an aspect of the present disclosure, a method of extruding a block product from a feed material is described. The method may include: flowing the feed material in a barrel towards an output end; receiving the feed material in a die from the output end of the barrel; and heating the feed material in the die to produce the block product by passing electric current through the feed material to heat the feed material by resistive heating.

According to another aspect, an apparatus for extruding a carbon block from a feed material, the apparatus comprising a barrel comprising an output end, a screw at least partially disposed within the barrel, and adapted to flow the feed material in the barrel towards the output end, a die in fluid communication with the output end of the barrel, and adapted to receive the feed material and heat the feed material to produce a carbon block, and at least one electrically conductive element for passing electric current through the feed material to heat the feed material by resistive heating.

According to another aspect, an apparatus for extruding a block product, the apparatus comprising a barrel comprising an output end a screw at least partially disposed within the barrel, and adapted to flow a feed material in the barrel towards the output end, a die in fluid communication with the output end of the barrel, and adapted to receive the feed material and heat the feed material to produce the block product; and at least one electrically conductive element for passing electric current through the feed material to heat the feed material by resistive heating.

In some embodiments, the at least one electrically conductive element is disposed along an interior of the die.

In some embodiments the at least one electrically conductive element comprises an annular conductive element radially disposed about the interior of the die.

In some embodiments a surface area of the at least one conductive element in contact with the feed material is approximately equal to or greater than a cross-sectional area of the die.

In some embodiments the screw is electrically grounded.

In some embodiments at least the interior of the die is formed of an electrically non-conducting material.

In some embodiments the barrel and the die are electrically isolated from one another.

In some embodiments the barrel and the die are coupled together by an electrically insulating element.

In some embodiments the at least one electrically conductive element is axially spaced apart from the output end of the barrel.

In some embodiments the apparatus further comprises at least one cooling element radially disposed about an exterior of the die.

In some embodiments the at least one electrically conductive element is disposed axially between the output end of the barrel and the at least one cooling element.

In some embodiments the apparatus further comprises a center rod at least partially disposed within the die generally along a central axis thereof.

In some embodiments at least an outer surface of the center rod is formed of an electrically non-conducting material.

According to another aspect, a method of extruding a block product from a feed material, the method comprising: flowing the feed material in a barrel towards an output end; receiving the feed material in a die from the output end of the barrel; and heating the feed material in the die to produce the block product by passing electric current through the feed material to heat the feed material by resistive heating.

In some embodiments the step of heating comprises passing the electric current through the feed material generally opposite to a flow direction of the feed material.

In some embodiments the step of heating comprises passing the electric current through the feed material radially inwardly from an interior of the die.

In some embodiments the step of heating comprises passing the electric current from at least one electrically conductive element disposed along the interior of the die.

In some embodiments the step of heating comprises passing the electric current from the at least one electrically conductive element to a screw at least partially disposed within the barrel.

In some embodiments the method further comprises electrically grounding the screw.

In some embodiments the method further comprises forming at least an interior of the die of an electrically non-conducting material.

In some embodiments the method further comprises electrically insulating the die from the barrel.

In some embodiments the method further comprises, after the step of heating, cooling the feed material in the die.

In some embodiments the method further comprises providing a center rod at least partially disposed within the die generally along a central axis thereof.

In some embodiments the method further comprises forming at least an outer surface of the center rod of an electrically non-conducting material.

In some embodiments, the feed material comprises activated carbon and at least one binder.

According to another aspect, a carbon block product produced by any one of the methods described herein.

Other aspects and features of the teachings disclosed herein will become apparent, to those ordinarily skilled in the art, upon review of the following description of the specific examples of the specification.

### BRIEF DESCRIPTION OF THE DRAWINGS

The drawings included herewith are for illustrating various examples of systems, apparatus and methods of the present disclosure and are not intended to limit the scope of what is taught in any way. In the drawings:

FIG. 1 is a sectional view of an example of an extrusion apparatus;

FIG. 2 is a schematic view of a portion of the extrusion apparatus of FIG. 1; and

FIGS. 3 to 5 are graphs showing the relationship between uniformity of heating and a length to diameter (L/D) ratio in tubular carbon block products.

### DETAILED DESCRIPTION

Various apparatuses or methods are described below to provide an example of an embodiment of each claimed invention. No embodiment described below limits any claims and claims may cover systems, apparatuses and methods that differ from those described below. The claims are not limited to apparatus, systems and methods having all of the features of any one apparatus, systems or method described below or to features common to multiple or all of the apparatus, systems or methods described below.

In some instances, it is possible that an apparatus, system or method described below is not an embodiment of any claim. Any subject matter disclosed herein that is not claimed in this document may be the subject matter of another protective instrument, and the applicant(s), inventor(s) and/or owner(s) do not intend to abandon, disclaim or dedicate to the public any such subject matter by its disclosure in this document.

In some cases, carbon block products may be produced by transfer compression molding, where ingredients are loaded into a mold, compressed or compacted, and then subjected first to heating and then to cooling to create a fused structure. This technique may produce a wide variety of shapes (although in some cases these shapes have a limited length-to-diameter ratio), and in some cases may allow the use of low melt-flow polymers as a binder that minimize carbon fouling.

However, these techniques may require a relatively large volume of binder, and the time required to accomplish the total molding cycle may be relatively long (e.g., about 2 hours for a complete cycle in some cases).

A second technique for carbon block production involves the direct extrusion of an activated carbon and binder mixture. In some cases, the binder used may be of intermediate melt-flow, and may allow relatively rapid melting and fusion of the particles. This binder may be generally less expensive than that used in molding processes, and the amount of binder may be reduced as compared to that used in molding processes. This may allow a greater proportion of activated carbon to be incorporated into the carbon block product.

According to this second technique, carbon block may be extruded using a solid-state extruder apparatus. The term “solid-state” refers to the fact that the carbon-binder mixture, even at elevated temperatures adequate to cause the binder to melt, may not actually flow, but is generally a porous and unsaturated composite material (meaning the amount of polymer is insufficient to fill the available pores between the non-melting particles) that remains generally solid. Under these conditions, convective and radiative heat transfers are generally not present, and heat flow may be limited to direct conduction.

The productivity of a carbon block production process using either the first or second technique may be limited by several factors. One factor is the difficulty of moving sensible heat into, and then subsequently out of, the geometry of a relatively thick-walled tube. In a thick-walled tube, heat flow is usually accomplished by conduction only, and the thermal conductivity of the carbon-binder mixture may be relatively low, meaning that the flow of heat through the tube is generally slow.

In general, concepts described herein pertain to the production of block products by resistive heating of a feed material while the feed material undergoes a solid-state (and in some cases continuous) extrusion process. These concepts may be applied to the production of carbon block products by extrusion of an activated carbon and binder feed material.

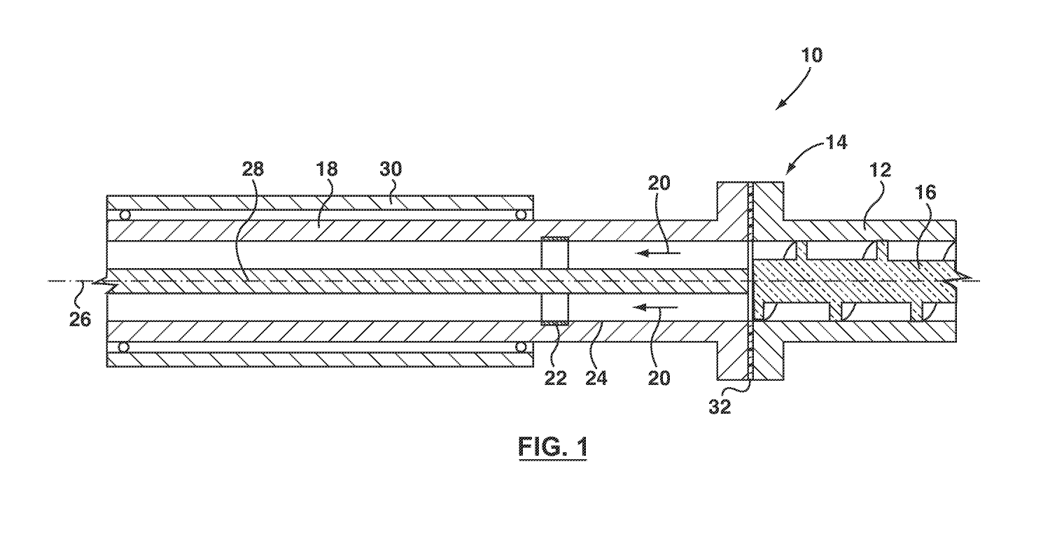

Referring now to FIG. 1, an example of an apparatus for extruding block products is shown generally at reference numeral 10. The apparatus 10 includes a barrel 12 having an output end 14. A screw 16 is at least partially disposed within the barrel 12. The screw 16 drives a flow of feed material in the barrel 12 towards the output end 14.

The apparatus 10 further includes a die 18 in fluid communication with the output end 14 of the barrel 12. The die 18 receives the flow of feed material, which is moving generally in a flow direction 20, from a tip of the screw 16 generally at the output end 14 of the barrel 12.

In some cases, preheating of the feed material in the barrel 12 may cause a softening or melting of the binder, which may in turn cause the feed material to become sticky and partially fixed in geometry. Under these conditions, the particles may not flow as a loose powder to fill the die 18, but instead may have a significant “memory” of the geometry of the screw 16 and the barrel 12. This may cause distinct helical screw-line artifacts within the resulting product.

In some cases, the feed material may be delivered as a cool, loose powder into the die 18 in order to produce carbon block products with good pore-structure uniformity. The feed material flows into the die 18 and allows particle randomization, thereby reducing or eliminating the tendency for the feed material to remember the geometry of the screw 16 and the barrel 12.

The apparatus 10 includes at least one electrically conductive element for passing electric current (generally direct current or DC) through the flow of feed material to heat the feed material by resistive heating. In the example illustrated, the die 18 includes an electrically conductive element 22 disposed along an interior 24 of the die 18.

In some cases, the electrically conductive element 22 may take the form of one or more annular members disposed about the interior 24 of the die 18. In the example illustrated, a single electrically conductive element 22 is generally flush with the interior 24 of the die, and is arranged to be generally concentric with a central axis 26 of the die 18. In other examples, a series of two or more electrically conductive elements may be positioned along the interior of the die, and various arrangements are possible.

In the example illustrated, a center rod 28 is at least partially disposed within the die 18, and is arranged generally along the central axis 26 thereof. The center rod 28 may serve to create the hollow cylindrical interior of the carbon block product. In some cases, the center rod 28 may be integral with the screw 16, and may rotate in unison with the screw 16. In some other examples, the center rod 28 may be detached from the screw 16. In some embodiments, the center rod 28 may be electrically isolated from the screw 16.

In the example illustrated, the electrically conductive element 22 is spaced apart from the output end 14 of the barrel 12, generally along the central axis 26. In operation, heating of the flow of feed material is accomplished through radial injection of electric current from the electrically conductive element 22 into the feed material, at least a portion of which is electrically conductive. The resulting electrical energy heats the feed material by resistive heating. The electric current is permitted to flow along the central axis 26, in general in a direction that is opposite to the flow direction 20, progressing radially inwardly toward the tip of the screw 16. In some cases, the screw 16 may be electrically grounded.

In some cases, the apparatus 10 may be configured to ensure that the electric current is directed from the electrically conductive element 22 to the tip of the screw 16, and not to the barrel 12, the die 18, and/or the center rod 28, for example. Accordingly, in some cases, at least the interior 24 of the die 18 may be formed of an electrically non-conducting material, and at least an exterior of the center rod 28 may be formed of an electrically non-conducting material. The non-conducting material may be, for example but not limited to, a non-conducting ceramic coating. Furthermore, in some cases, as illustrated, the barrel 12 and the die 18 may be coupled together by an electrically insulating element 32.

However, it should be appreciated that the surface area of the conductive element 22, in contact with the flow of feed material, should be sufficient so as to avoid localized overheating of the feed material. In some cases, this may be accomplished by ensuring that the surface area of the conductive element 22 in contact with the flow of feed material is at least approximately equal to, or greater than, an open cross-sectional area of the die 18.

The movement of feed material may be regulated (e.g., by controlling the speed of the screw 16 or via other techniques) to allow sufficient time within the portion of the die 18 between the electrically conductive element 22 and the tip of the screw 16 for the feed material at the center, i.e. in contact with the center rod 28, to reach fusion temperature.

Thereafter, the die 18 may provide adequate cooling so that the extrudate emerges with sufficient structural integrity to complete cooling outside of the die 18.

In the example illustrated, a cooling mechanism 30 is radially disposed about an exterior of the die 18. The cooling mechanism 30 may be circulated with cooling water or another fluid to remove heat from the extrudate in the die 18. In some cases, the cooling mechanism 30 may include one or more air cooling elements, such as a fan, a heat exchanger, and so on.

Using the apparatus 10, the rate of heating of the feed material may be relatively high. For example, and not intended to be limiting, suitable heating of the carbon block product may be accomplished in time frames of 10-20 seconds for thin-walled products, and approximately 600 seconds (10 minutes) for some thick-walled products. Accordingly, this may contribute to high production speeds. Moreover, in some cases a relatively large portion of the die, and in some cases the majority of die length, may be used for cooling.

Furthermore, rapid heating may reduce the amount of time the outer portion of the carbon block product is exposed to a temperature greater than the Vicat softening point of the binder. This may reduce incidence of carbon fouling, in which the binder flows into the activated carbon, and in some cases may allow the use of less stable catalytic carbons as a portion of the feed material.

Using the apparatus 10, the flow of feed material may be heated generally uniformly. Numerical calculations using an isotropic electric current flow model, without thermal re-distribution, may be used to show that for common commercial carbon block product geometries, highly uniform heating of the feed material in the apparatus 10 may be possible, as described in further detail herein. Modeling may also enable the geometry of the apparatus 10 to be adjusted to achieve a desired uniformity of heating for a given feed material and particular dimensions of the completed block.

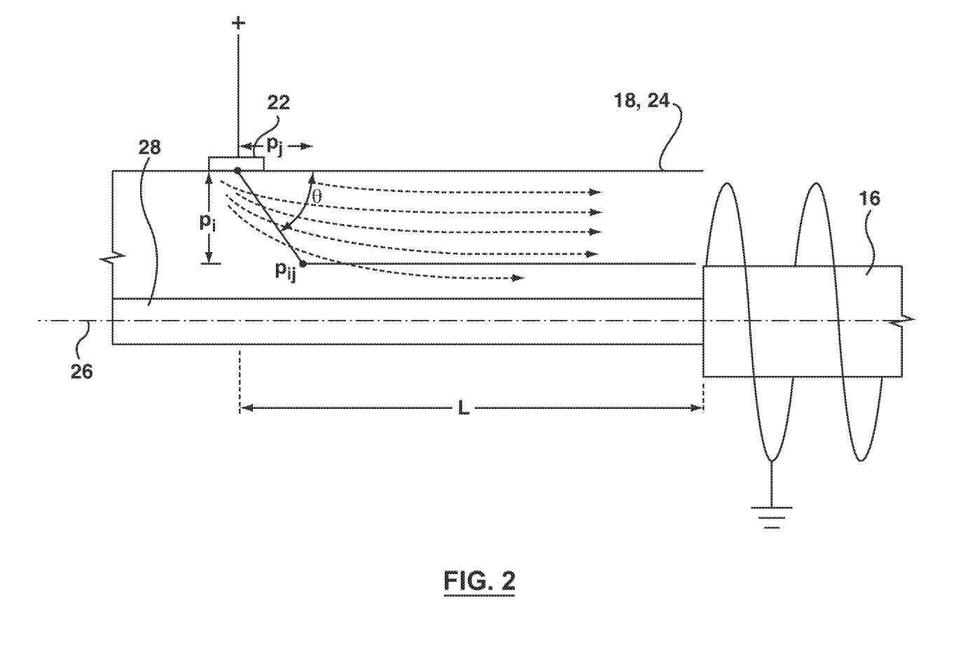

For the purposes of modeling, the three-dimensional arrangement of the apparatus 10 may be simplified to a two-dimensional case as illustrated in FIG. 2, which focuses on the heated zone of the die 18 of the apparatus 10. It may be assumed that the conductive element 22 along the interior 24 of the die 18 is narrow in comparison to the total length of the heated zone, and may be converted to a point source to provide a useful approximation. The extrudate carbon block product has an outside radius rₒ and an inside radius rᵢ. The length of carbon within the heating zone of the die is L. Thus, as illustrated, locations within the die 18 may be designated as p_{i,j}.

Starting at the electric power injection point of the conductive element 22, angle Θ is defined as:

tan Θ=pᵢ/pⱼ, so Θ=tan⁻¹(pᵢ/pⱼ) and h_{i,j}=pᵢ/sin Θ (Eq. 1),

where h_{i,j} is the hypotenuse to the location p_{i,j} and will be used in calculating electrical resistance as shown below. Assuming an isotropic and uniform structure, the electric potential at any location within the carbon block V_{i,j} is:

V_{i,j}=Vₒ cos Θ (Eq. 2),

where Vₒ is the total electric potential applied to the system. The electrical resistance for power to move through any given point within the carbon block (R_{i,j}) is:

R_{i,j}=h_{i,j}+(L−Pᵢ) (Eq. 3).

This holds because resistance in an isotropic medium is simply equal to the total distance between two points. Using the basic electrical rules that V=I R and total electrical energy E=I² R=V²/R, then two solvable integrals may be obtained. The following equations now hold:

R_{i,j}=cos[pᵢ/sin(tan⁻¹(pᵢ/pⱼ))]+(L−pⱼ),

V_{i,j}=cos(tan⁻¹(pᵢ/pⱼ)),

E_{i,j}=V_{i,j}²/R_{i,j}, and

[cos(tan⁻¹(pᵢ/pⱼ)]²]/{[pᵢ/sin(tan⁻¹(pᵢ/pⱼ)]+(L−pⱼ)} (Eq. 4).

This may be converted an algebraic form where x=p₁/pⱼ and:

E_{i,j}=(1/(1+x²)^{1/2})²/{[pᵢ/(x/(1+x²)^{1/2}]+(L−pⱼ)} (Eq. 5).

Using either equations (4) or (5) above, a numerical calculation of the electrical energy flow through the carbon block may be carried out by using suitable increments of pᵢ and pⱼ.

Breaking the length within the heated zone, L, into increments of pⱼ=0.1 L and making a similar breakdown across pᵢ, software calculations may be carried out to look at various arrangements of carbon block products and design of the apparatus 10. This may be accomplished using a spreadsheet to calculate an array down and across a proposed design, and run a proposed combination of dimensions of the extruded carbon block product.

To obtain cross-sectional uniformity of the heating, the total energy may be integrated in each radial row of the calculation. If extremes of the ID and OD of the carbon block product are examined and the ratio of total energy at these extreme radial locations are calculated, the ratio may be a measure of the uniformity of the heating process from the inside to the outside of the resulting carbon block product. This may be a dimensionless ratio and may be referred to as a “Heating Uniformity Index” (HUI). Conventional extruded carbon block products may have a HUI of as low as 0.25 to 0.50, for example. A more suitable value of 0.75 would yield certain benefits, and a value greater than 0.90 may yield additional benefits. A higher HUI generally corresponds to a more uniform product.

More particularly, in some carbon block production processes, an exterior surface of the carbon block product may be exposed to significantly greater heat, and for a much longer period, than the portion adjacent to the center rod. This may result in higher melting of the binder, and more carbon fouling on the exterior surface. Thus, in a conventional carbon block product with a relatively low HUI, significant differences in porosity, strength and other characteristics may be present between the inner portions of the block and the outer portions of the block. These differences may be reduced or even substantially eliminated when the HUI is sufficiently high.

To further improve the modeling approach described herein, two aspects may be refined. Firstly, for thick-walled products, there may be a supplemental calculation of heat flow during production as such heat flow makes the uniformity of the heating potentially much higher. Secondly, any change in the thermal conductivity of the carbon-binder mixture with temperature may also be included.

In the event of a conventional increase in electrical resistance with rising temperature, this may also lead to a superior result with more uniform heating. That is, as the outer radius of the extrusion heats faster, its electrical resistance would rise, which would favor the diversion of power to the colder (and lower resistance) inner core of the extrusion, which is desirable.

The methodology described herein was used to investigate carbon block product designs to examine heating uniformity and optimization. Reference is now made to the following examples, which are intended to be illustrative but non-limiting.

### A Thin-Walled Product

The heating uniformity of a thin-walled carbon block product having 1.90″ OD and 1.1875″ ID dimensions was examined. A first step was to identify an apparatus geometry that may achieve a desired HUI. To do this, the model described above was run with varying dimensions specified for the electrical energy injection point to produce a plot of HUI versus a length to diameter (L/D) ratio. This may be done to generate a range of relevant HUI values.

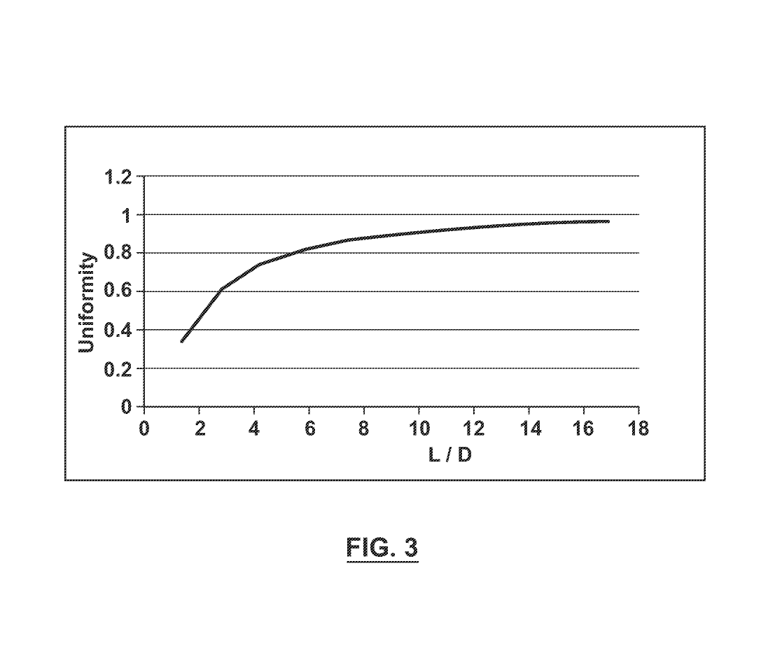

FIG. 3 shows the change in HUI (defined as the ratio of energy arriving at the outside diameter versus inside diameter) of a carbon mass when the extrusion has an outside diameter of 1.90 inches (radius=2.413 cm) and inside diameter of 1.1875 inches (radius=1.508 cm) for varying length of the heated zone, L. In this thin-wall design, an acceptable distance, L, for heating the carbon mass may be as short as 4 cm (uniformity=0.75) and there is little benefit to provide a heating zone greater than 8.89 cm (uniformity=0.9). If the total extrusion die is roughly 15 inches (38 cm) in length, then the heating zone is only 12-23% of the die length and this leaves space for an extended cooling mechanism.

In some cases, cooling may be the rate-limiting aspect of this type of extrusion. Hence, in this thin-walled design, the maximum speed of extrusion may be limited by the requirement to bring at least some portion of the product significantly below the Vicat softening point of the binder, for example.

The cooled portion of the product should sustain the structural integrity of the product while it completes the cooling process outside of the extrusion die. If such cooling is provided by an exterior cooling mechanism, then the exterior of the product will be cooled, but the internal portion might continue to be at an elevated temperature. This may be advantageous, to ensure a suitable time-temperature history of the interior portion of the product, which may be more exposed to a lower temperature than the exterior. This may serve to make the uniformity of heating better than calculated according to the model described herein.

### A Medium-Walled Product

The heating uniformity of a medium walled carbon block product having 2.50″ OD and 1.25″ ID dimensions was examined, which is a size that is commonly used within the consumer water filter industry and fits a known housing that includes a filter element, having compression gaskets on either end, and captured between opposing blunt knife edges that engage these gaskets.

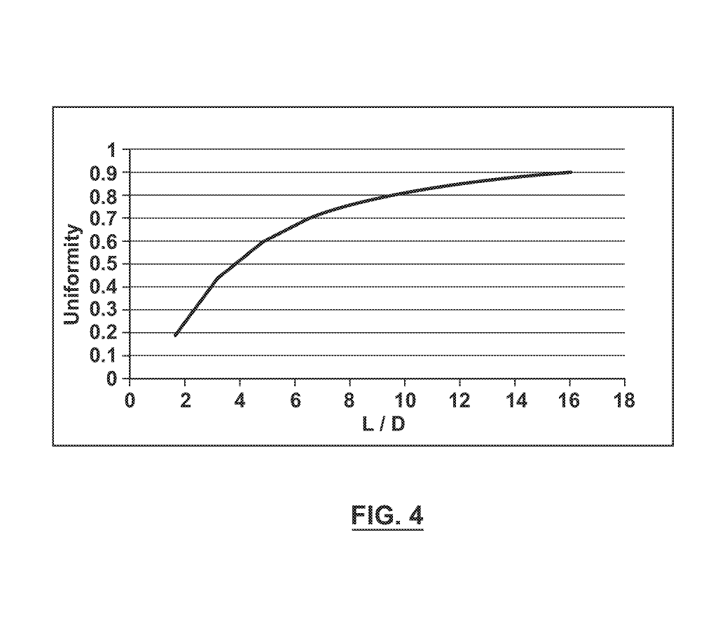

FIG. 4 shows how heating uniformity changes as the length of the heating zone increases (shown as the ratio L/D, where L is the length of the heat zone and D is thickness of the product extrusion).

The heating uniformity is generally not the same for different geometries. A thick-walled product may be more difficult to heat in this arrangement because the electric current must enter the feed material from a radial direction, and then flow to the screw. This may result in a portion of the feed material adjacent to the center rod being at lower temperature than that the portion in the path of the electric current directed from the conductive element to the screw adjacent to the die wall. According to calculations, an acceptable uniformity (0.75) may be achieved at a L/D ratio of roughly 8.0 (12.7 cm=5″ length), and this is nearly 25% of the available die length. Highly uniform energy injection (uniformity=0.9) may be achieved when the heating zone is twice this distance, or almost 50% of the available die length.

### A Thick-Walled Product

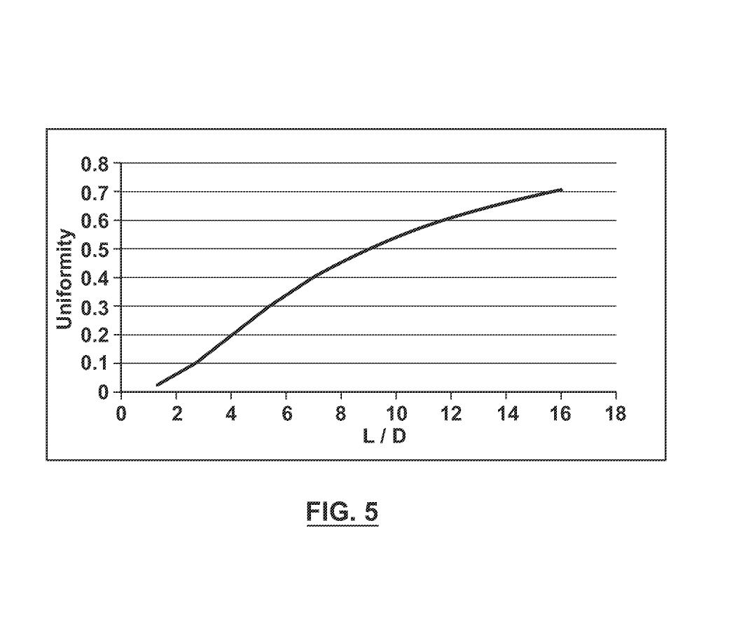

The heating uniformity of a thick-walled carbon block product having 4.25″ OD and 1.25″ ID dimensions was examined. FIG. 5 shows the change in HUI as L/D is varied in a thick-walled geometry. Here, the extruded carbon block wall is 3.81 cm thick, and the projected overall die length is usually in the range of 60-65 inches. However, even at a L/D ratio of 16, the uniformity of the heating process is only 0.7, which may be acceptable. Hence, a 24″ heating zone consisting nearly 37% of the die length might produce results that are not optimal. However, in the thick-walled situation, a supplemental heat flow calculation may be included to account for the diffusion of heat through the extruded body. This supplemental redistribution of heat contributes to heating uniformity, and makes production of products with these dimensions feasible.

While the above description provides examples of one or more apparatuses and methods, it will be appreciated that other apparatuses and methods may be within the scope of the accompanying claims.

1. An apparatus for extruding a carbon block for water filtration from a feed material comprising activated carbon, the apparatus comprising:
a barrel comprising an output end;
a screw at least partially disposed within the barrel, and adapted to flow the feed material in the barrel towards the output end;
a die in fluid communication with the output end of the barrel, and adapted to receive the feed material and heat the feed material to produce the carbon block; and
at least one electrically conductive element for passing electric current through the feed material to heat the feed material by resistive heating.

2. An apparatus for extruding a block product from a feed material, the apparatus comprising:
a barrel comprising an output end;
a screw at least partially disposed within the barrel, and adapted to flow the feed material in the barrel towards the output end;
a die in fluid communication with the output end of the barrel, and adapted to receive the feed material and heat the feed material to produce the block product; and
at least one electrically conductive element for passing electric current through the feed material to heat the feed material by resistive heating.

3. The apparatus of claim 2, wherein the at least one electrically conductive element is disposed along an interior of the die.

4. The apparatus of claim 2, wherein the at least one electrically conductive element comprises an annular conductive element radially disposed about the interior of the die.

5. The apparatus of claim 2, wherein a surface area of the at least one conductive element in contact with the feed material is approximately equal to or greater than a cross-sectional area of the die.

6. The apparatus of claim 2, wherein the screw is electrically grounded.

7. The apparatus of claim 2, wherein at least the interior of the die is formed of an electrically non-conducting material.

8. The apparatus of claim 2, wherein the barrel and the die are electrically isolated from one another.

9. The apparatus of claim 2, wherein the barrel and the die are coupled together by an electrically insulating element.

10. The apparatus of claim 2, wherein the at least one electrically conductive element is axially spaced apart from the output end of the barrel.

11. The apparatus of claim 2, further comprising at least one cooling element radially disposed about an exterior of the die.

12. The apparatus of claim 11, wherein the at least one electrically conductive element is disposed axially between the output end of the barrel and the at least one cooling element.

13. The apparatus of claim 2, further comprising a center rod at least partially disposed within the die generally along a central axis thereof.

14. The apparatus of claim 13, wherein at least an outer surface of the center rod is formed of an electrically non-conducting material.

15. A method of extruding a block product from a feed material, the method comprising:
flowing the feed material in a barrel towards an output end;
receiving the feed material in a die from the output end of the barrel; and
heating the feed material in the die to produce the block product by passing electric current through the feed material to heat the feed material by resistive heating.

16. The method of claim 15, wherein the step of heating comprises passing the electric current through the feed material generally opposite to a flow direction of the feed material.

17. The method of claim 15, wherein the step of heating comprises passing the electric current through the feed material radially inwardly from an interior of the die.

18. The method of claim 15, wherein the step of heating comprises passing the electric current from at least one electrically conductive element disposed along the interior of the die.

19. The method of claim 15, wherein the step of heating comprises passing the electric current from the at least one electrically conductive element to a screw at least partially disposed within the barrel.

20. The method of claim 19, further comprising electrically grounding the screw.

21. The method of claim 15, further comprising forming at least an interior of the die of an electrically non-conducting material.

22. The method of claim 15, further comprising electrically insulating the die from the barrel.

23. The method of claim 15, further comprising, after the step of heating, cooling the feed material in the die.

24. The method of claim 15, further comprising providing a center rod at least partially disposed within the die generally along a central axis thereof.

25. The method of claim 15, further comprising forming at least an outer surface of the center rod of an electrically non-conducting material.

26. The method of claim 15, wherein the feed material comprises activated carbon and at least one binder.
